(19) United States
(12) Patent Application Publication
(10) Pub. No.: US 2010/0050395 A1
(43) Pub. Date: Mar. 4, 2010

(54) Stationery clip

(76) Inventor: Nick Hsu, Taichung (TW)

Correspondence Address: COOPER & DUNHAM, LLP, 30 Rockefeller Plaza, 20th Floor, NEW YORK, NY, 10112, US

(21) Appl. No.: 12/231,109

(22) Filed: Aug. 29, 2008

(51) Int. Cl. B42F 1/00

(52) U.S. Cl. 24/67.3; 24/67 R

(57) ABSTRACT

A stationery clip has a body, an insert and an arm. The body has a chamber and a back. The back has two insertion holes, two grooves and two shoulders. The insertion holes are formed in the back. The grooves are transversely defined in the back adjacent to the insertion holes. The shoulders are formed transversely on the back adjacent to a corresponding groove. The insert having a design is removably mounted in the chamber of the body. The arm is mounted in the insertion holes and grooves and abuts the shoulders. Therefore, the design of the insert is not damaged and abraded easily and can be frequently changed. The stationery clip can have a unique design and the arm is held in place without adhesive.

### BACKGROUND OF THE INVENTION

1. Field of the Invention

The present invention relates to a, especially to be a durable stationery clip with an easily exchangeable design.

2. Description of the Prior Arts

With reference to FIGS. 6 to 8, a stationery clip in accordance with the prior art has a body (90) and an arm (80). The body (90) has a front, a back and two insertion holes (91). The insertion holes (91) are formed in the back of the body (10). The arm (80) has two insertion ends (82). The insertion ends (82) correspond to the insertion holes (91) of the body (90) and are mounted therein using an adhesive. The stationery clip is used to clamp at least one sheet of the paper between the body (90) and the arm (80) to display a message.

The message is printed on the front of the body (90). However, the design is easily abraded and damaged and is not easily changed. Furthermore, the adhesive loses adhesion with time leading to terminal failure.

Therefore, a conventional stationery clip having a unique design is impossible and once the design is damaged or abraded the stationery clip must be replaced entirely.

To overcome the shortcomings, the present invention provides a stationary clip to mitigate or obviate the aforementioned problems.

### SUMMARY OF THE INVENTION

The main objective of the present invention is to provide a durable stationery clip with an easily exchangeable design.

A stationery clip in accordance with the present invention has a body, an insert and an arm. The body has a chamber and a back. The back has two insertion holes, two grooves and two shoulders. The insertion holes are formed in the back. The grooves are transversely defined in the back adjacent to the insertion holes. The shoulders are formed transversely on the back adjacent to corresponding grooves: The insert having a design is removably mounted in the chamber of the body. The arm is mounted in the insertion hole and grooves and abuts the shoulders. Therefore, the design of the insert is not damaged and abraded easily and can be frequently changed. The stationery clip can have a unique design and the arm is held in place without adhesive.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a stationery clip in accordance with the present invention;

FIG. 2 is a rear perspective view of the stationery clip in FIG. 1;

FIG. 3 is an exploded perspective of the stationery clip in FIG. 1;

FIG. 4A is a side view in partial section of the stationery clip along line 4A-4A in FIG. 2;

FIG. 4B is a side view in partial section of the stationery clip along line 4B-4B in FIG. 2;

FIG. 4C is an enlarged cross sectional side view of the stationery clip in FIG. 4A;

FIG. 5 is a front view of the stationery clip in FIG. 1, shown clipping paper;

FIG. 6 is a rear perspective view of the stationery clip in accordance with the prior art;

FIG. 7 is a rear exploded perspective of the stationery clip in FIG. 6; and

FIG. 8 is a front view of the stationery clip in FIG. 6, shown clipping the paper.

### DETAILED DESCRIPTION OF THE PREFERRED EMBODIMENTS

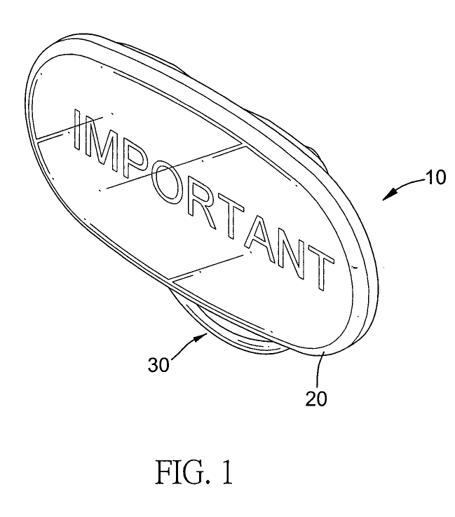

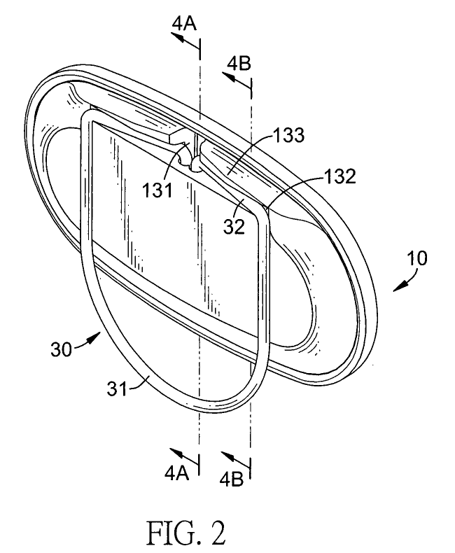

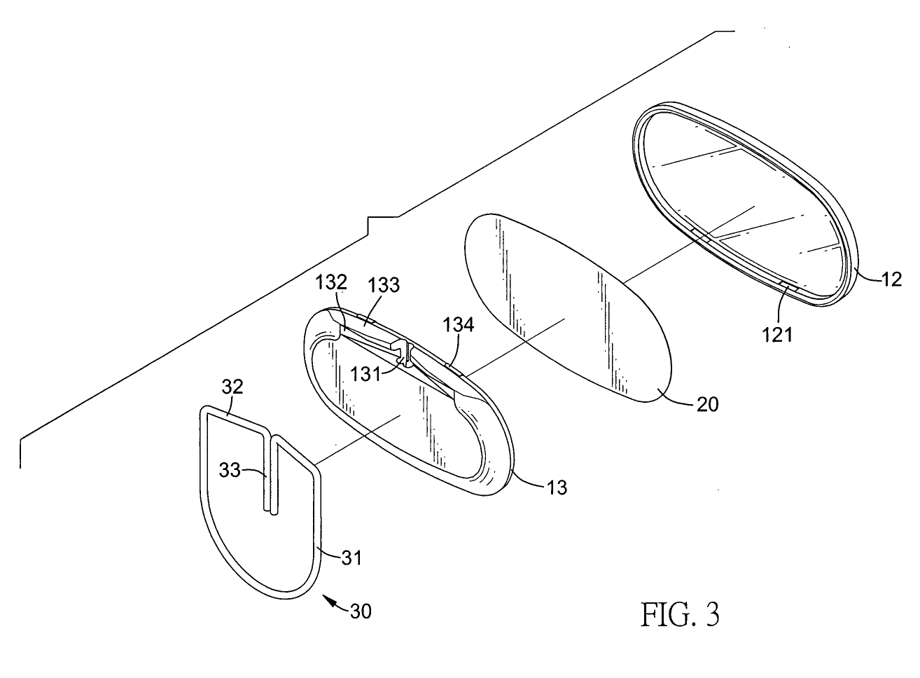

With reference to FIGS. 1 to 3, a stationery clip in accordance with the present invention has a body (10), an insert (20) and an arm (30).

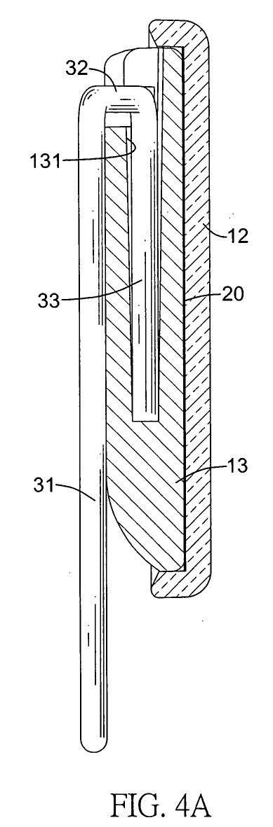

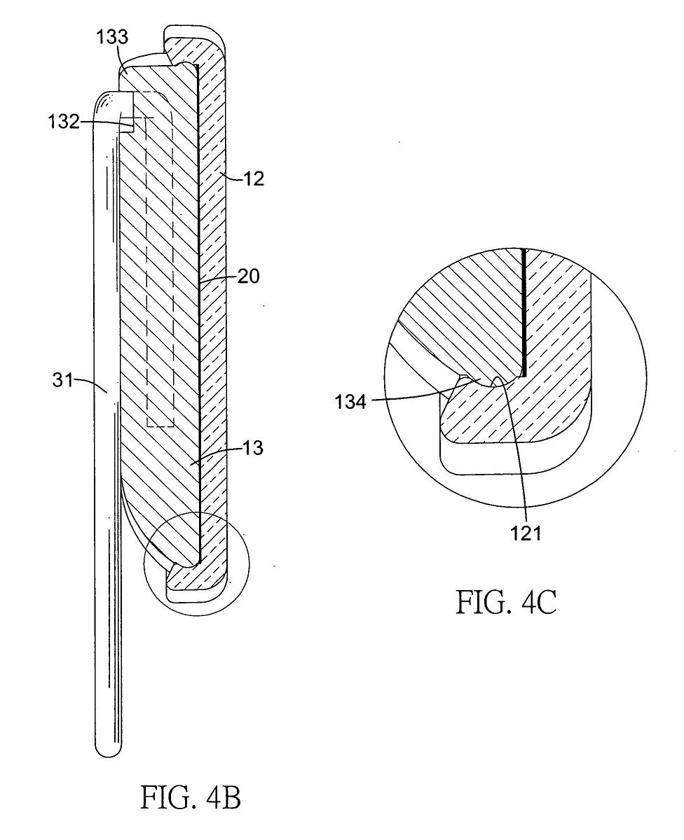

The body (10) has a chamber and a back. The body (10) may comprise a front cover (12) and a rear cover (13). The chamber is formed in the body (10), may be between the front and rear covers (12, 13). The front cover (12) is diaphanous and has a rim and multiple fastening recesses (121). The fastening recesses (121) are defined in the rim of the front cover (12). The rear cover (13) has an edge, an inner surface, an outer surface and multiple optional fastening tabs (134). The back may be formed in the outer surface of the rear cover (13) and has two insertion holes (131), two grooves (132) and two shoulders (133). The insertion holes (131) are defined in the back of the body (10). The grooves (132) are transversely defined in the back of the body (10) adjacent to the insertion holes (131). The shoulders (133) are formed transversely on the back of the body (10) adjacent to corresponding grooves (132). With further reference to FIGS. 4A 4B and 4C, the fastening tabs (134) are formed on the edge and mounted respectively in the fastening recesses (121) of the front cover (12). The chamber is formed between the front cover (12) and the rear cover (13).

The insert (20) is removably mounted in the chamber of the body (10) may be between the front and rear covers (12, 13) and has an outer surface. The outer surface of the insert (20) has a design such as a picture, word, advertisement or the like.

The arm (30) is resilient, is mounted in the insertion holes (131) and has two insertion ends (33), two transverse sections (32) and a loop (31). The insertion ends (33) are mounted in the insertion holes (131). The transverse sections (32) are formed on and extend respectively from the insertion ends (33), correspond to the grooves (132) of the rear cover (13) and abut the shoulders (13). The loop (31) is U-shaped and is formed on and connects the transverse sections (32). When the arm (30) is mounted in the insertion holes (131), the transverse sections (32) are mounted in the grooves (132) and abut the shoulders (133) of the rear cover (13) to prevent the transverse sections (32) being separated from the rear cover (13).

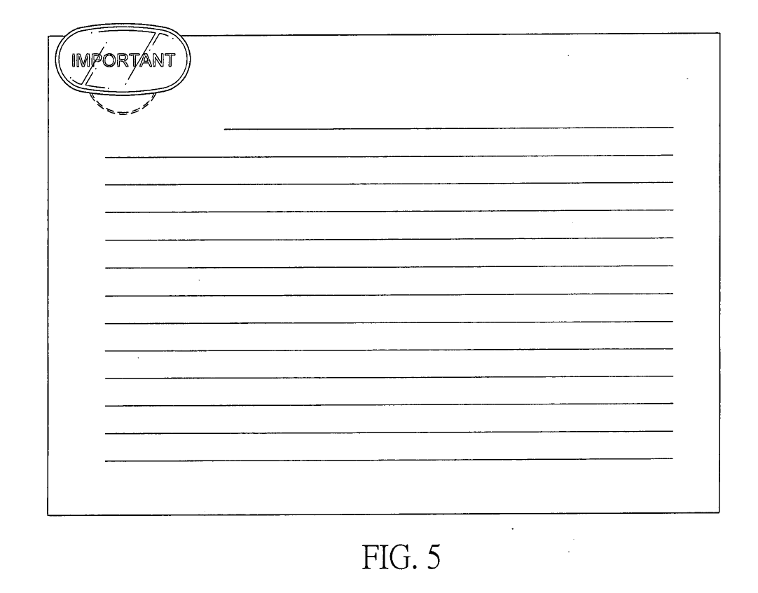

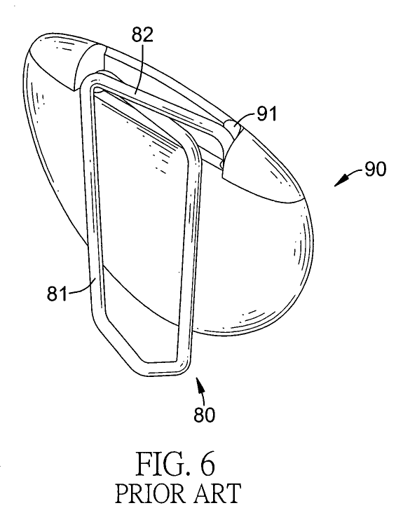

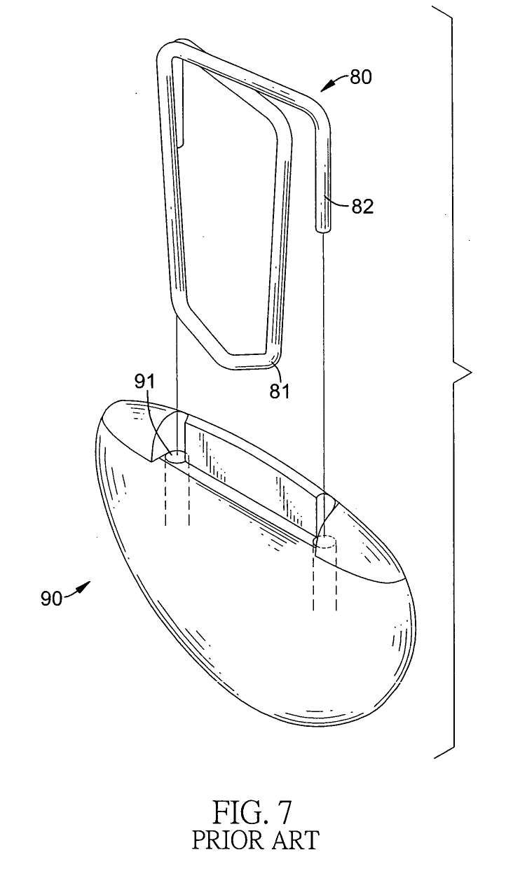

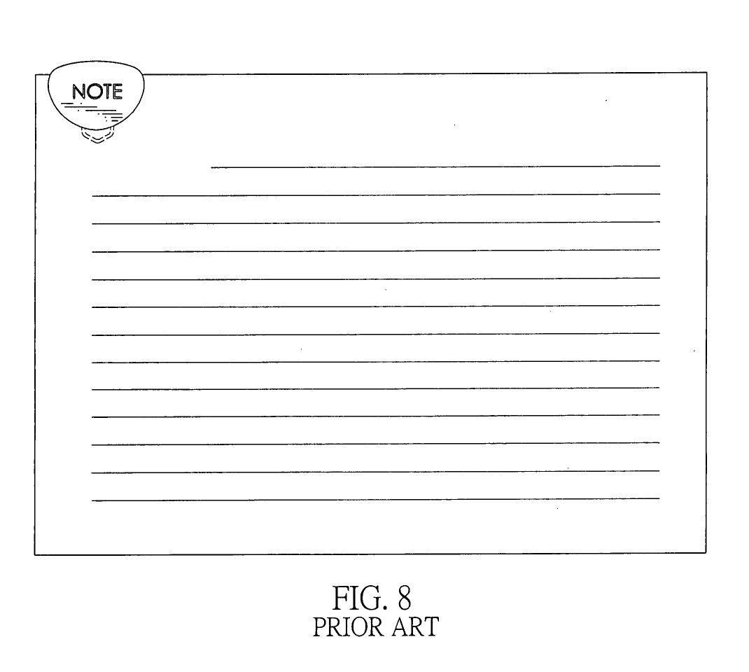

With further reference to FIG. 5, the insert (20) of the stationery clip is removably mounted in the chamber, may be between the front cover (12) and the rear cover (13), so the design of the insert (20) is not damaged and abraded easily. Therefore, the stationery clip can be updated frequently by changing the design of the insert (20) to ensure that the stationery clip always has a unique design.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stationery clip comprising
a body having
a chamber being formed in the body; and
a back having
two insertion holes being formed in the back;
two grooves being transversely defined in the back and adjacent to the insertion holes; and
two shoulders being formed transversely on the back adjacent respectively to the grooves;
an insert being removably mounted in the chamber of the body and having an outer surface having a design; and
an arm being mounted in the insertion holes and having
two insertion ends being mounted in the insertion holes; two transverse sections being formed on and extending respectively from the insertion ends, corresponding to the grooves and abutting the shoulders; and
a loop being formed on and connecting the transverse sections.

2. The stationery clip as claimed in claim 1, wherein the body further comprises
a front cover having
a rim; and
multiple fastening recess being defined in the rim of the front cover; and
a rear cover having
an edge;
an inner surface;
an outer surface; and
multiple fastening tabs being formed on the edge and mounted respectively in the fastening recess of the front cover, wherein
the chamber is formed between the front and rear covers;
the insert is mounted between the front and rear covers; and
the back of the body is formed in the outer surface of the back cover.

3. The stationery clip as claimed in claim 2, wherein the front cover is diaphanous.
